(19) United States
(12) Patent Application Publication
(10) Pub. No.: US 2014/0288882 A1
(43) Pub. Date: Sep. 25, 2014

(54) Processing Abnormality Detection Method and Processing Device

(71) Applicants: Nobuaki Nakasu, Tokyo (JP); Hideaki Onozuka, Tokyo (JP)

(72) Inventors: Nobuaki Nakasu, Tokyo (JP); Hideaki Onozuka, Tokyo (JP)

(73) Assignee: Hitachi, Ltd., Chiyoda-ku, Tokyo (JP)

(21) Appl. No.: 14/126,198

(22) PCT Filed: Jun. 25, 2012
(86) PCT No.: PCT/JP2012/066102

§ 371 Date: Jun. 2, 2014

(30) Foreign Application Priority Data
Sep. 2, 2011 (JP) 2011-191257

(51) Int. Cl. G01M 13/00

(52) U.S. Cl. CPC G01M 13/00
USPC 702/183

(57) ABSTRACT

A cutting state quantity caused by processing, in which a cutting tool is rotated, is measured, cutting force components containing a fundamental and harmonics are extracted from a measured signal, a threshold for abnormality determination is calculated on the basis of harmonic ratios that are ratios between the fundamental and harmonics of the cutting force components, a cutting force is calculated from the extracted cutting force components, and an abnormality is determined on the basis of the calculated cutting force and the calculated threshold.

### TECHNICAL FIELD

The present invention relates to methods for monitoring processing states in machine processing and for detecting abnormalities, and also relates to processing devices.

### BACKGROUND

A machine processing method is a typical processing method used for various kinds of metal processing, in which a material to be cut is cut in by a cutting blade mounted on a rotary tool, and various shapes of the metal can be obtained after shavings are removed. In the case where a part having a complex shape is processed, because a large quantity of shavings are incurred, an attempt to increase the efficiency of the metal processing has been made by increasing the cutting-in quantity, the blade feed quantity, and the rotation speed of the tool, or by other means.

Increasing the cutting-in quantity and the rotation speed of the tool apply a large force to the cutting blade, with the result that various processing troubles such as the vibration of the tool, the abrasion and breakage of the cutting blade are apt to occur. If the processing troubles occur, the surface of a processed part becomes conspicuously rough or damaged. Therefore the part must be discarded, with the result that the part is wasted and the cost of discarding the part is also required. In view of the above, it becomes indispensable to configure a system in which the processing condition of the system can be changed, or the processing can be stopped just before an abnormality occurs.

In the related art, as a method for detecting the abrasion of a tool, a method in which an abnormality is detected by comparing the load of a main motor used for a main axis rotation with a preset threshold is well known. In this instance, the load of the main motor is estimated through the measurement of the value of the motor drive current. As one of methods for presetting the above threshold, Patent Literature 1 discloses an invention in which, after grasping the variation pattern of the value of the motor drive current in advance through experiments and simulations, a threshold is set for each processing path with reference to this variation pattern.

### CITATION LIST

### Patent Literature

Patent Literature 1: Japanese Unexamined Patent Application Publication No. Hei5 (1993)-337790

### SUMMARY OF INVENTION

### Technical Problem

However, the above method, in which the threshold is preset for each processing path, is applicable only to a processing path where the cutting-in quantity is constant, and it is not applicable to a processing path where the cutting-in quantity varies and the load of the processing varies. In addition, in the processing of a material of complex three-dimensional shape, many short processing paths are required. However, it is difficult to set a threshold for each processing path.

It is an object of the present invention to provide a method in which a cutting force abnormality detection threshold can be dynamically detected even in a processing path having a time-varying cutting-in quantity.

### Solution to Problem

To address the above-mentioned problem, for example, the configuration of a processing device, which will be described in the appended claims, can be adopted. The present invention includes plural means for addressing the above-mentioned problems. In one of the plural means, the judgment of a processing abnormality is made in the following way, for example. A signal generated by rotary cutting is measured, and cutting force components including a fundamental and harmonics are extracted from the measured signal. A threshold for abnormality detection is calculated on the basis of ratios between the fundamental and harmonics of the cutting force components, and the cutting force is calculated on the basis of the cutting force components. The judgment of the processing abnormality is made by comparing the cutting force with the threshold.

### Advantageous Effects of Invention

According to an embodiment of the present invention, because a cutting force abnormality threshold can be dynamically determined in accordance with the variation of a cutting-in quantity, the setting accuracy of the cutting force abnormality detection threshold can be improved, and the processing accuracy can be improved as well.

### BRIEF DESCRIPTION OF DRAWINGS

FIG. 1 is a flowchart for explaining a processing abnormality detection method according to a first embodiment of the present invention;

FIG. 2 is a diagram for explaining the configuration of a processing device according to this embodiment of the present invention;

FIG. 3 is a diagram for explaining a determination method of a direction in which an abnormality is determined in a processing path having a small variation of a radial cutting-in quantity;

FIG. 4 is a diagram for explaining a determination method of a direction in which an abnormality is determined in a processing path having a large variation of the radial cutting-in quantity;

FIG. 5A is a diagram showing a processing state in the case of the radial cutting-in quantity being small;

FIG. 5B is a diagram showing a cutting force;

FIG. 5C is a diagram showing an example of the frequency-converted result of the cutting force;

FIG. 6A is a diagram showing a processing state in the case of the radial cutting-in quantity being large;

FIG. 6B is a diagram showing a cutting force;

FIG. 6C is a diagram showing an example of the frequency-converted result of the cutting force;

FIG. 7A is a diagram for explaining a method for formulating the variation of the radial cutting-in quantity;

FIG. 7B is a diagram for explaining a method for formulating the variation of the radial cutting-in quantity;

FIG. 7C is a diagram for explaining a method for formulating the variation of the radial cutting-in quantity;

FIG. 8 is a diagram for explaining the harmonics of the frequency-converted result of the cutting force;

FIG. 9A is a diagram for explaining a method for determining an abnormality detection threshold according to the first embodiment;

FIG. 9B is a diagram for explaining a method for determining an abnormality detection threshold according to the first embodiment;

FIG. 10 is a diagram showing the configuration of the processing device according to the first embodiment of the present invention;

FIG. 11 is a schematic diagram showing an example of an input screen where a setting method of processing conditions is input;

FIG. 12 is a diagram showing an example of a file format regarding library information shown in FIG. 11;

FIG. 13 is a diagram showing an example of file information;

FIG. 14 is a schematic diagram showing an example of an input screen where an input method of an abnormality detection threshold is input;

FIG. 15 is a diagram showing an example of the outline of an input screen that is shown when transition from the previous screen occurs;

FIG. 16 is a diagram showing an example of file format information;

FIG. 17 is a diagram showing an example of an input screen shown after transition from the previous screen;

FIG. 18 is a diagram showing examples of setting items based on the library information;

FIG. 19 is a diagram showing an input screen after transition from the previous screen;

FIG. 20 is a diagram showing an example of the display of setting items based on the library information; and

FIG. 21 is a diagram for explaining the detail of a threshold conversion coefficient calculation unit.

### DESCRIPTION OF EMBODIMENTS

Hereinafter, the embodiments of the present invention will be described with reference to the accompanying drawings. In the following description, the same components are given the same referential numbers, and redundant explanations regarding these components will be omitted.

### First Embodiment

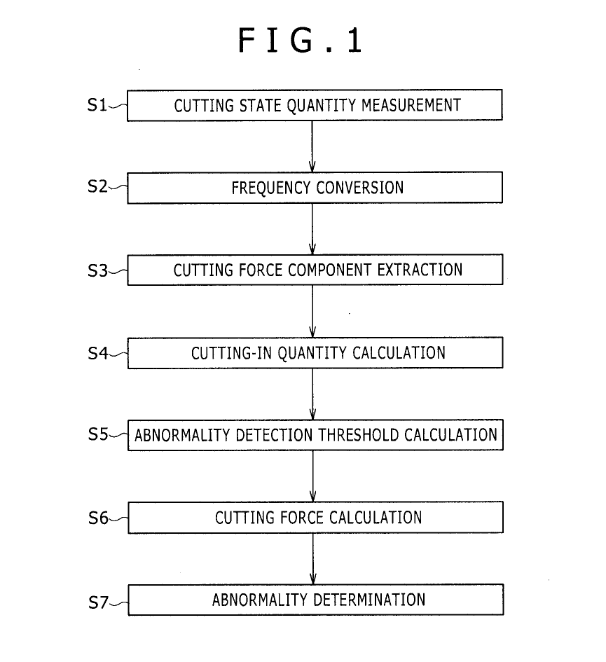

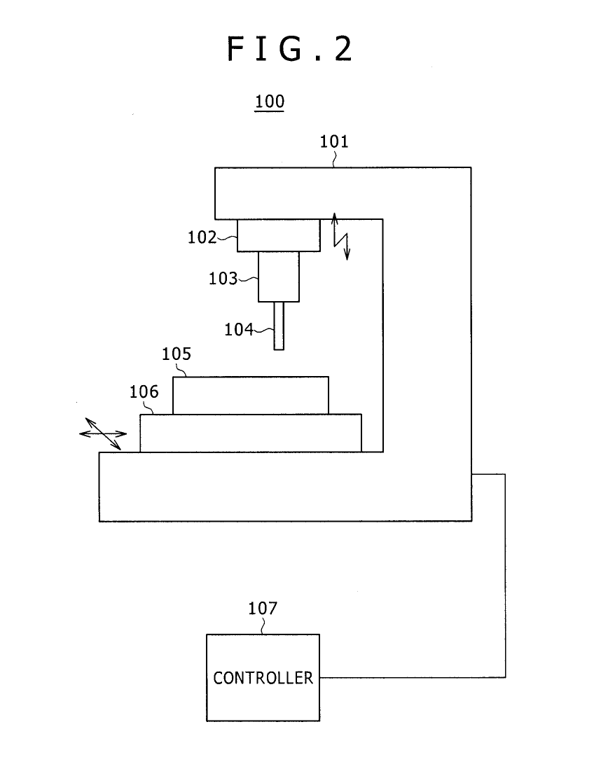

A first embodiment will be described with reference to FIG. 1 to FIG. 9C. FIG. 2 is a diagram for explaining the device configuration of a typical machine processing device used in this embodiment. In this embodiment, although the following description will be made under the assumption that the machine processing device is triaxially controlled, a machine processing device to which the present invention is applicable is not limited to the machine processing device described in this embodiment in terms of its number of control axes and its configuration. The machine processing device 100 includes a chassis 101, a processing tool 104, a main axis 103 that holds and rotates the processing tool 104, a main axial stage 102 that moves the main axis 103 in the axial direction, a material to be cut 105, a table 106 that holds and moves the material to be cut 105, and a controller 107 that controls the machine processing device 100. An MPU (not shown) in the controller 107 functions as a frequency conversion unit, a cutting force component extraction unit, a cutting force calculation unit, an abnormality determination unit, a cutting-in quantity calculation unit, and an abnormality detection threshold calculation unit by executing the corresponding programs. The above units will be described later. In addition, a memory (not shown) in the controller 107 includes a processing condition storage unit, a cutting-in quantity conversion coefficient storage unit, and a threshold conversion coefficient storage unit. In the machine processing device 100, the material to be cut 105 is cut in by rotating the processing tool 104, and the material to be cut is removed, with the result that the material to be cut 105 is shaped into a desired form. Owing to a force the processing tool 104 receives from the material to be cut 105, the processing tool 104 and the chassis 101 are vibrated, which leads to troubles such as the deterioration of the surface of the processed material and the breakage of the processing tool 104.

FIG. 1 is a process flowchart for explaining a processing abnormality detection method. First, a cutting state quantity measurement is performed (at step S1), and the frequency conversion of the measured signal is performed (at step S2). Next, cutting force component extraction is performed (at step S3), and a cutting-in quantity calculation is performed with the use of the extracted signals (at step S4). Next, after an abnormality detection threshold calculation is performed (at step S5) with the use of calculated harmonic ratios, a cutting force calculation, in which a cutting force is calculated by performing inverse frequency conversion on the cutting force components extracted in the cutting force component extraction (at step S3), is performed (at step S6). Lastly, abnormality determination is performed (at step S7) by comparing the cutting force calculated in the cutting force calculation (at step S6) and the threshold calculated in the abnormality detection threshold calculation (at step S5).

In the cutting state quantity measurement (at step S1), a cutting state quantity is measured using a sensor (not shown). Generally speaking, in order to measure the cutting state quantity, any of the outputs of sensors such as a force sensor signal, the value of a drive current for a main axis motor, an acceleration sensor signal, an acoustic signal, and an acoustic emission can be used. The force sensor can be installed by being embedded in the table 106 or in the main axial stage 102, or by being disposed in a state of being sandwiched between the material to be cut 105 and the table 106. Because the value of the drive current for the main axis motor is proportional to a force that causes the processing tool 104 to rotate, it becomes possible to measure a processing load. The acceleration sensor and the acoustic emission sensor are mounted mainly on the chassis 101, the main axial stage 102, or the table 106, and respectively measure the vibration of the machine processing device. The acoustic signal, which is a sound generated along with the vibration of the machine processing device, is collected by a microphone or the like.

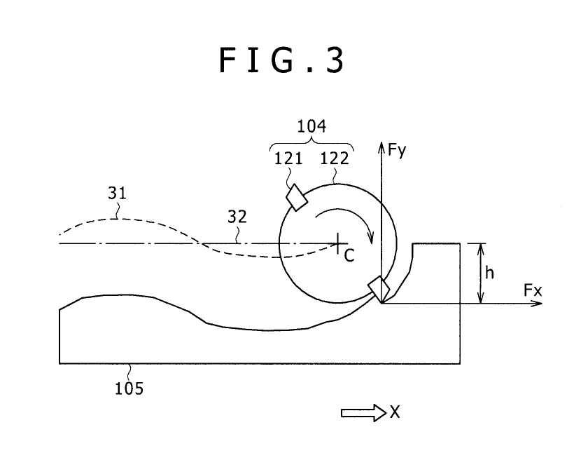

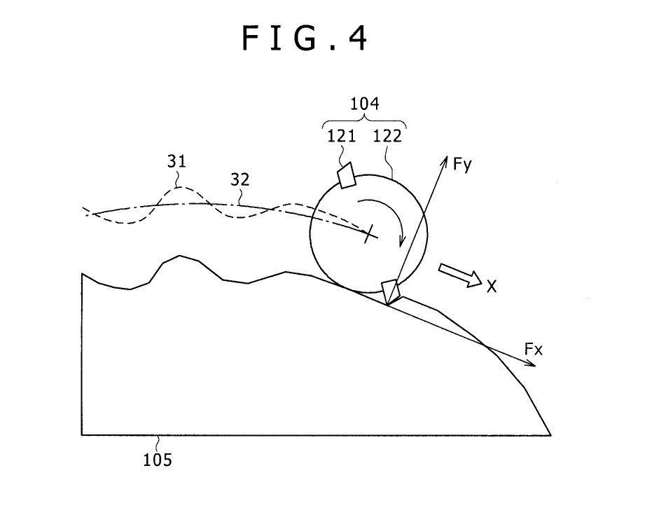

With reference to FIG. 3 and FIG. 4, axial directions that are used in a signal analysis will be explained. The processing tool 104 has a configuration including two chips 121 each of which has a cutting blade formed on a rotation axis 122. The processing tool 104 rotates on its rotation center C, and processes the material to be cut 105 by making the chips 121 cut in the material to be cut 105. Although it is assumed that the two chips 121 shown in FIG. 3 and FIG. 4 are mounted on the rotation axis 122 in the above description, other processing tools that are equipped with the chips 121 whose number is other than two can be also used.

As the axial directions used in the signal analysis, three axial directions, that is, a direction along which the axial cutting-in is performed (perpendicular to the surface of the drawing sheet of FIG. 3 or FIG. 4), a direction of moving the processing tool 104, and a direction along which the radial cutting-in is performed and which is perpendicular to the above two directions. In the case where the direction of moving the processing tool X is almost constant and the moving average line 32 of the trajectory 31 depicted by the rotation center of the rotation axis 122 becomes almost a linear line as shown in FIG. 3, the direction of moving the processing tool X can be considered to be fixed. On the other hand, in the case where the direction of moving the processing tool X largely varies and the moving average line 32 of the trajectory 31 depicted by the rotation center of the rotation axis 122 becomes a curve as shown in FIG. 4, the signal analysis can be performed by converting the coordinate system regarding a measured signal so that a signal component in the tangential direction to the moving average line of the current rotation center is set to Fx and a signal component in the perpendicular direction to the moving average line 32 is set to Fy.

It is not always indispensable to make abnormality determinations regarding the above three directions in the case of performing abnormality detection. It will be sufficient to judge whether there is an abnormality or not with the use of, for example, the signal component Fy in the radially cutting-in direction, which is a typical direction. Alternatively, it is conceivable to judge whether there is an abnormality or not with the use of, for example, a signal component in the direction where the variation of the cutting state quantity conspicuously appears. The direction where the variation of the cutting state quantity conspicuously appears is dependent on the mounting angles of the chips 121, the direction of moving the tool, and the like.

At the frequency conversion (at step S2), the frequency conversion unit in the controller 107 performs frequency conversion on the measured value of the cutting state quantity. As a method to be used for frequency conversion, a typical technological method such as discrete Fourier transform or Fast Fourier transform can be used. At the cutting force component extraction (at step S3), the cutting force component extraction unit in the controller 107 extracts the frequency components of the cutting force. To take the output of the force sensor for example, the signal measured by the force sensor includes components caused by a cutting force generated owing to the removal of shavings, and a vibration force generated owing to the vibrations of the processing tool and the like. By performing frequency conversion on this measured signal, the frequency components of the signal can be divided into a cutting force frequency component that is determined by the rotation speed of the tool and the number of the cutting blades (for example, if a processing tool 104 with two cutting blades is rotated at a rotation speed 3300 min⁻¹, the cutting force frequency becomes 110 Hz (=2×3300 min⁻¹/60)), and a vibration frequency component that is determined by the characteristic frequency of the processing tool 104. In other words, in the cutting force component extraction (at step S3), the rotation speed of the processing tool is calculated on the basis of the rotation speed of the main axis motor, and the frequency of a fundamental is obtained by multiplying the rotation speed of the processing tool by the number of the blades. In addition, the components of the fundamental frequency and its harmonic frequencies, which are nearly integral multiples of the fundamental frequency, are extracted from the measured signal as the cutting force components.

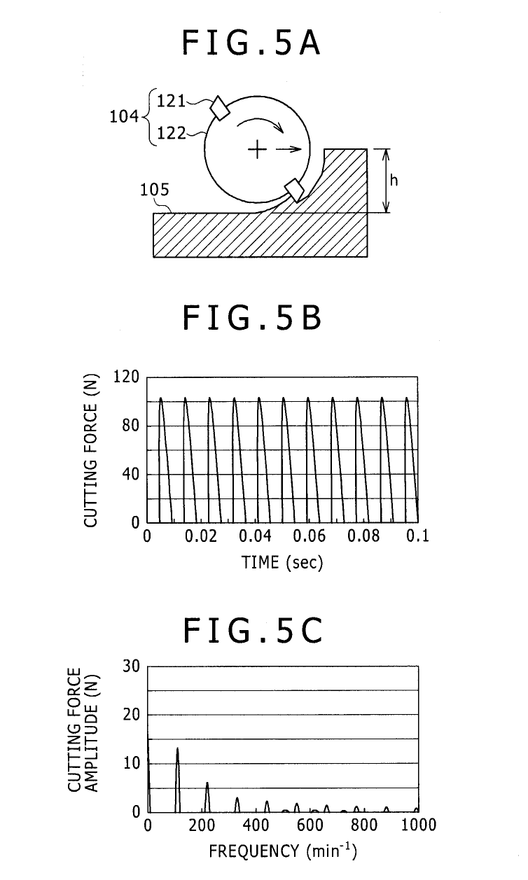

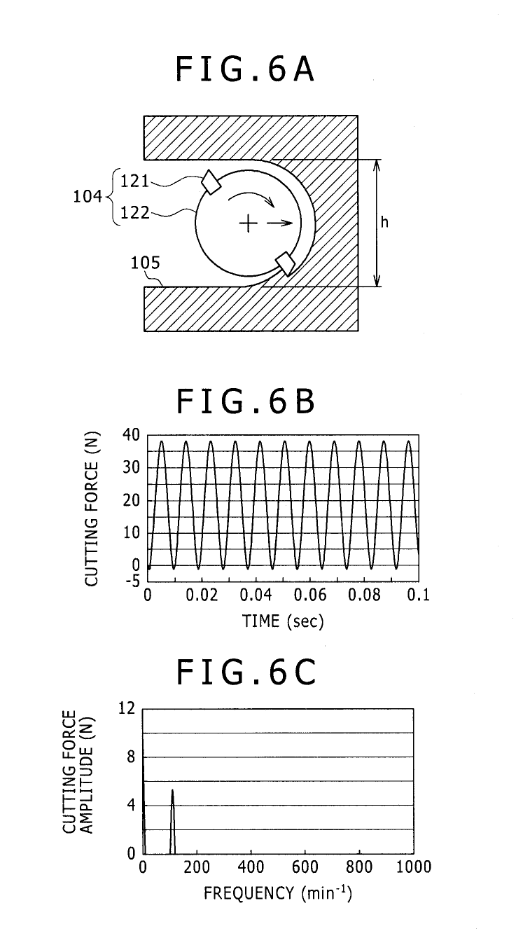

In the cutting-in quantity calculation (at step S4), the cutting-in quantity calculation unit in the controller 107 calculates a radial cutting-in quantity. The calculation of the radial cutting-in quantity will be described with reference to FIG. 5A, FIG. 5B, FIG. 5C, FIG. 6A, FIG. 6B, and FIG. 6C. Each of FIG. 5A to FIG. 5C is a diagram showing a processing state in the case of the radial cutting-in quantity h being small, where the radial cutting-in quantity h is almost equal to the radius of the processing tool 104.

FIG. 5B is a diagram showing an example of a cutting force signal obtained when the tool is rotated at the rotation speed of 3300 min⁻¹. The cutting force is generated at the interval of 0.009 sec in accordance with the rotation speed of the tool, and because there are time periods during which both of the two chips 121 are rotated without cutting the material to be cut (these time periods are referred to as the idle running time periods of the chips 121 hereinafter), the cutting forces are intermittently applied to the material to be cut. FIG. 5C is a diagram showing an example of the frequency-converted result of the cutting force shown in FIG. 5B. The component of the fundamental frequency 110 Hz (2×3300 min⁻¹/60), which corresponds to the rotation speed of the tool 3300 min⁻¹, and the components of the harmonic frequencies, which are integral multiples of the fundamental frequency, are generated. The harmonics are generated because the cutting force is intermittently applied to the material to be cut and it has a discontinuous waveform. Each of FIG. 6A to FIG. 6C is a diagram showing a processing state in the case of the radial cutting-in quantity h being large, where the radial cutting-in quantity h is almost equal to the diameter of the processing tool 104. The cutting force has a continuous waveform because there are no idle running time periods of the chips 121. Therefore, the frequency-converted result of the cutting force shows that only a signal with the fundamental frequency 110 Hz is generated.

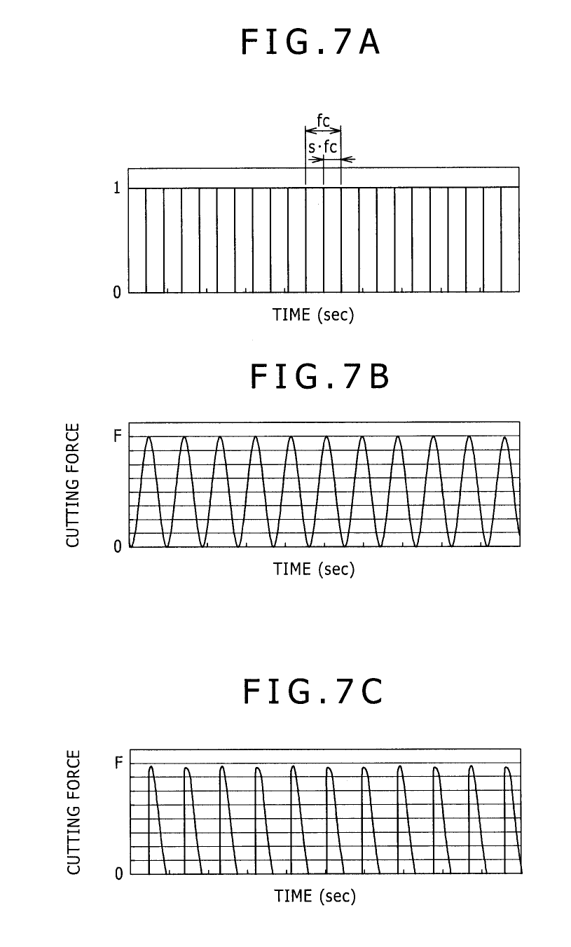

The cutting force signal shown in FIG. 6B can be approximated by a cosine wave, and the cutting force signal shown in FIG. 5B has a waveform obtained by removing a waveform during the idle running periods of the chips 121 shown in FIG. 5B from the waveform shown in FIG. 6B. Therefore, the waveform shown in FIG. 5B can be obtained by multiplying the waveform in FIG. 6B by a window function that causes only parts of the waveform of the signal in FIG. 6B during the time periods during which the chips 121 are cutting in the material to be cut 105 to be valid. A method for deriving a relational expression between the cutting-in quantity h and the cutting force waveform, and Fourier transform will be explained with reference to FIG. 7A, FIG. 7B, and FIG. 7C.

FIG. 7A is a diagram showing the window function. The window function is a rectangular wave having a magnitude 1, and it will be assumed that the cycle and width of the rectangular wave are respectively represented by fc and s·fc. The rectangular ratio s is a value related to the idle running time periods of the chips 121, and it takes the value of 0≦s≦1. FIG. 7B is a diagram showing a cutting force waveform in the case of a radial cutting-in quantity in FIG. 7B being equal to that in FIG. 6B. In FIG. 7B, it will be assumed that the maximum value of the cutting force is F, and the cycle of the cutting force is fc, which is equal to that of the window function. FIG. 7C is a diagram showing a waveform obtained by multiplying the cutting force waveform (FIG. 7B) by the window function (FIG. 7A), and this waveform corresponds to the waveform shown in FIG. 5B.

The window function M(t) shown in FIG. 7A is given by Expression 1. The descriptions will be made using an angular frequency ω for simplicity, where the relation between ω and fc is given by ω=2πfc.

$$\begin{matrix}[ Formula 1 ] & \\ M ( t ) = s - \frac{1}{π} {\sum }_{n = 1}^{∞} \{ \frac{cos ( n π )}{n} ( 1 - cos ( 2 π ns ) ) \cdot sin ( n ω t ) - \frac{cos ( n π )}{n} \cdot sin ( 2 π ns ) \cdot cos ( n ω t ) \} & Expression 1\end{matrix}$$

In addition, the cutting force waveform G(t) shown in FIG. 7B is given by Expression 2. Expression 2 is an expression that mathematizes the cutting force waveform in the case where the two chips 121 are disposed evenly spaced apart on the periphery of the rotation axis 122, and Expression 2 is dependent on the number of the chips, the intervals between the chips, and the size of the rotation axis.

$$\begin{matrix}[ Formula 2 ] & \\ G ( t ) = \frac{F}{2} ( 1 + cos ( ω t ) ) & Expression 2\end{matrix}$$

The cutting force waveform H(t) shown in FIG. 7C in the case of the radial cutting-in quantity being small is given by Expression 3.

$$\begin{matrix}[ Formula 3 ] & \\ H ( t ) = M ( t ) \cdot G ( t ) = \frac{F \cdot s}{2} + \frac{F \cdot s}{2} cos ( ω t ) + \frac{F}{8 π} \{ 3 sin ( ω t ) - 4 sin ( ω t + 2 π s ) + sin ( ω t + 4 π s ) \} + \frac{F}{2 π} {\sum }_{n = 2}^{∞} \{ \frac{{( - 1 )}^{n}}{n ( {n}^{2} - 1 )} sin ( n ω t ) + \frac{{( - 1 )}^{n}}{n} sin ( n ω t + 2 n π s ) \} + \frac{F}{4 π} {\sum }_{n = 2}^{∞} \{ - \frac{{( - 1 )}^{n}}{n - 1} sin ( n ω t + 2 π ( n - 1 ) s ) - \frac{{( - 1 )}^{n}}{n + 1} sin ( n ω t + 2 π ( n + 1 ) s ) \} & Expression 3\end{matrix}$$

If the radius of the processing tool 104 is represented by r, the number of the chips 121 is by N, the relation between the rectangular ratio s and the radial cutting-in quantity h is given by Expression 4.

$$\begin{matrix}[ Formula 4 ] & \\ s = 1 - \frac{N}{2 π} {cos}^{- 1} ( \frac{h - r}{r} ) & Expression 4\end{matrix}$$

From Expression 3 and Expression 4, it turns out that the magnitudes of the harmonic components are functions of the radial cutting-in quantity h, and the radial cutting-in quantity h can be calculated from the harmonic ratios.

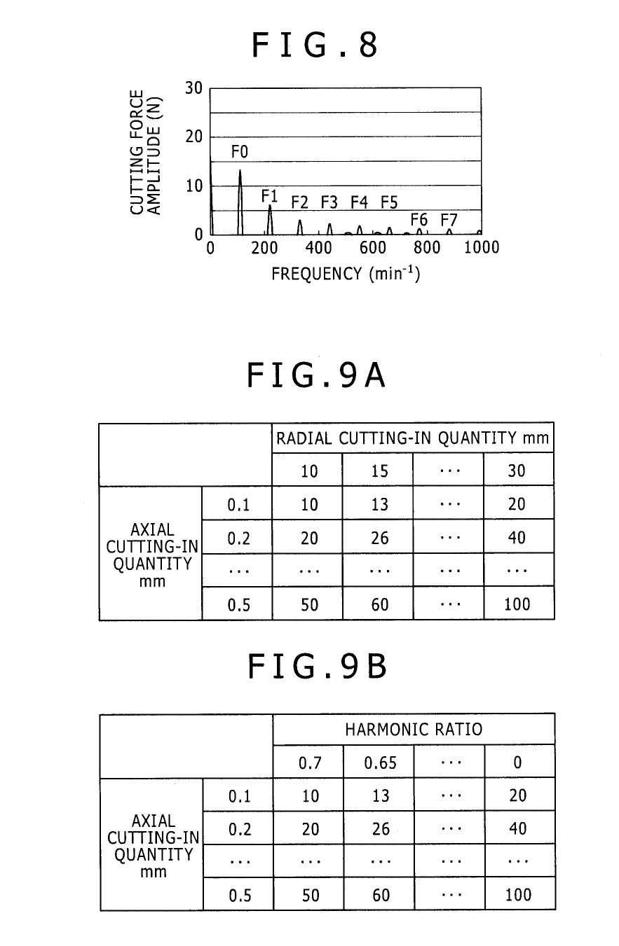

An example of a method for calculating the radial cutting-in quantity from the harmonic ratios will be described below. As shown in FIG. 8, it will be assumed that the fundamental frequency corresponding to the rotation speed of the tool is represented by F0, the first harmonic frequency by F1, and the nth harmonic frequency by Fn. From Expression 3 and Expression 4, it turns out that F1/F0, F2/F0, . . . , Fn/F0 are functions of the radial cutting-in quantity h, and they are not dependent on other parameters (for example, the axial cutting-in quantity, and the rigidities of the processing tool 104 and the material to be cut 105). From Expression 3, the fundamental F0(t) and the first harmonic F1(t) are respectively given by Expression 5 and Expression 6.

$$\begin{matrix}[ Formula 5 ] & \\ F 0 ( t ) = \frac{F}{8 π} \{ 3 sin ( ω t ) - 4 sin ( ω t + 2 π s ) + sin ( ω t + 4 π s ) \} + \frac{F \cdot s}{2} cos ( ω t ) = \frac{F}{8 π} \sqrt{\begin{matrix}26 - 32 cos ( 2 π s ) + 6 cos ( 4 π s ) + \\ 8 π s \{ sin ( 4 π s ) - 4 sin ( 2 π s ) \} + 16 {π}^{2} {s}^{2}\end{matrix}} \cdot sin ( ω t + α ) & Expression 5 \\ [ Formula 6 ] & \\ F 1 ( t ) = \frac{F}{12 π} \{ sin ( 2 ω t ) + 3 sin ( 2 ω t + 4 π s ) - 3 sin ( 2 ω t + 2 π s ) \} - sin ( 2 ω t + 6 π s ) = \frac{F}{12 π} \sqrt{20 - 27 cos ( 4 π s ) - 20 cos ( 6 π s ) - 3 cos ( 8 π s )} \cdot sin ( 2 ω t + β ) & Expression 6\end{matrix}$$

It will be assumed that the power spectra obtained by Fourier transforming F0(t) and F1(t) are respectively represented by P0 and P1. Since P0=|F0(t)|², and P1=|F1(t)|², P1/P0 is given by Expression 7 from Expression 5 and Expression 6.

$$\begin{matrix}[ Formula 7 ] & \\ \frac{P 1}{P 0} = \frac{4}{9} \cdot \frac{20 - 27 cos ( 4 π s ) - 20 cos ( 6 π s ) - 3 cos ( 8 π s )}{\begin{matrix}26 - 32 cos ( 2 π s ) + 6 cos ( 4 π s ) + \\ 8 π s \{ sin ( 4 π s ) - 4 sin ( 2 π s ) \} + 16 {π}^{2} {s}^{2} \end{matrix}} & Expression 7\end{matrix}$$

With the use of an actually measured value of P1/P0 and Expression 7, the rectangular ratio s is calculated, and the cutting-in quantity h can be calculated using Expression 4. As a method for calculating the rectangular ratio s from Expression 7, a commonly used technological method such as Runge-Kutta method, Euler method, or a simulation can be used.

Another method for calculating the radial cutting-in quantity using the harmonic ratios will be described. It will be assumed that harmonic ratios derived from Expression 3 are represented by P1s/P0s, P2s/P0s, . . . , Pns/P0s, and harmonic ratios obtained by actually measured values are represented by P1m/P0m, P2 m/P0m, . . . , Pnm/P0m. Here, Expression 8 is defined as an error function for this method, and when Expression 8 is calculated using the cutting-in quantity h as a parameter, the optimum value of the cutting-in quantity h is a value of the cutting-in quantity h that makes the error function minimum. It is conceivable to calculate the value of the rectangular ratio s that makes the error function of Expression 8 minimum with the use of Expression 4 that defines the relation between the rectangular ratio s and the cutting-in quantity h. In addition, it is all right if Expression 8 is calculated to an adequately high-order term. In other words, it is not always necessary to calculate Expression 8 to an infinitely high-order term. As a method for calculating the rectangular ratio s from Expression 8, a commonly used technological method such as Runge-Kutta method, Euler method, or a simulation can be used.

$$\begin{matrix}[ Formula 8 ] & \\ E = {\sum }_{n = 1}^{∞} {( \frac{Pns}{P 0 s} - \frac{Pnm}{P 0 m} )}^{2} & Expression 8\end{matrix}$$

Another method for calculating the radial cutting-in quantity using the harmonic ratios will be described. Harmonic ratios (P1/P0, P2/P0, . . . , Pn/P0) regarding each of plural rectangular ratios s are calculated in advance with the use of a simulation or an experiment, and the harmonics ratios regarding each of the rectangular ratios s are stored. Next, actually measured harmonic ratios (P1 m/P0m, P2 m/P0m, . . . , Pnm/P0m) regarding each of plural rectangular ratios s are used. Lastly, a rectangular ratio s that makes an error function (Expression 9) minimum is selected. In this case, as the number of the rectangular ratios s is increased, the accuracy of the rectangular ratio s that makes the error function minimum is more improved.

$$\begin{matrix}[ Formula 9 ] & \\ E = {\sum }_{n = 1}^{∞} {( \frac{Pn}{P 0} - \frac{Pnm}{P 0 m} )}^{2} & Expression 9\end{matrix}$$

An example of a method for calculating the axial cutting-in quantity will be described below. The magnitude F of the cutting force is represented as F=C·w, where C is a constant that is determined by the rigidities of the processing tool 104 and the material to be cut 105 and w is the axial cutting-in quantity. Expression 3 shows that the DC component is F·s/2, so F·s/2 is represented by C·w·s/2. If the actually measured DC component of the cutting force is represented by L, L is given by Expression 10. If the constant C is obtained in advance by a simulation or an experiment, the axial cutting-in quantity w can be calculated from Expression 11 with the use of the actually measured value L of the DC component and the rectangular ratio s obtained from Expression 7, Expression 8, or Expression 9.

$$\begin{matrix}[ Formula 10 ] & \\ \frac{C \cdot w \cdot s}{2} = L & Expression 10 \\ [ Formula 11 ] & \\ w = \frac{2 L}{C \cdot s} & Expression 11\end{matrix}$$

An abnormality detection threshold calculation (at step S5) performed by the abnormality detection threshold calculation unit in the controller 107 will be described below. The magnitude F of the cutting force used in Expression 3 is dependent on the rigidities of the processing tool 104 and the material to be cut 105, the radial cutting-in quantity, and the axial cutting-in quantity. Among the above parameters, parameters that can be changed during the processing are the radial cutting-in quantity and the axial cutting-in quantity. Therefore, if a table such as shown in FIG. 9A is made to include thresholds with these two quantities as parameters, it becomes possible to refer to this table for information regarding the thresholds. In this case, cutting forces under the various conditions are derived in advance by a simulation or an experiment, and thresholds corresponding to the magnitudes of the cutting forces are stored in the above table, with the result that the thresholds under the various conditions are obtained by referring to the table. Because the relation between the radial cutting-in quantities and the harmonic ratios are given from the Expression 3, a table shown in FIG. 9B, in which the radial cutting-in quantities of the table shown in FIG. 9A are replaced with the harmonic ratios, can be used in stead of the table shown in FIG. 9A.

Alternatively, after a cutting force F is calculated from Expression 12, an abnormality detection threshold corresponding to the cutting force F can be obtained by adding a margin D to this cutting force F.

$$\begin{matrix}[ Formula 12 ] & \\ F = C \cdot w = \frac{2 L}{s} & Expression 12\end{matrix}$$

In the cutting force calculation (at step S6), the cutting force calculation unit in the controller 107 calculates the magnitude of the cutting force by performing inverse Fourier transform on the frequency components extracted in the cutting force component extraction (at step S3). At the abnormality detection (at step S7), the abnormality determination unit in the controller 107 detects a cutting abnormality by comparing the cutting force calculated at step S6 with the abnormality detection threshold calculated at step S5.

According to this embodiment, a method, in which a cutting force abnormality detection threshold can be dynamically set in a processing path having a time-varying radial cutting-in quantity, can be provided, which enables defective goods to be prevented from being produced by processing failures, and which enables the production cost to be reduced at the same time.

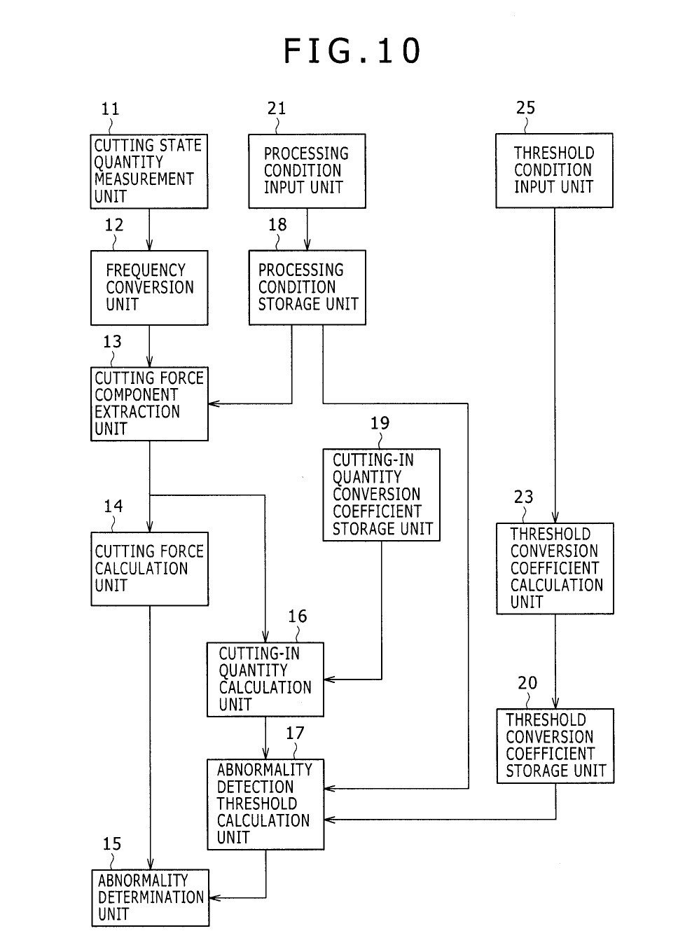

FIG. 10 is a diagram showing the configuration of parts of the controller 107 in the processing device, in which the parts are related to the processing abnormality detection. The MPU of the controller 107 functions as a cutting state quantity measurement unit 11, a frequency conversion unit 12, a cutting force component extraction unit 13, a cutting force calculation unit 14, an abnormality determination unit 15, a cutting-in quantity calculation unit 16, and an abnormality detection threshold calculation unit 17. The memory of the controller 107 includes a processing condition storage unit 18, a cutting-in quantity conversion coefficient storage unit 19, a threshold conversion coefficient storage unit 20, a processing condition input unit 21, a threshold conversion coefficient calculation unit 23, and a threshold condition input unit 25.

The cutting state quantity measurement unit 11, which includes a force sensor, a sensor for the value of a drive current for a main axis motor, an acceleration sensor, an acoustic sensor, an acoustic emission sensor, is a means for measuring a cutting force and the variation of a signal caused by the vibration of the machine processing device. The force sensor can be installed by being embedded in the table 106 or in the main axial stage 102, or by being disposed in a state of being sandwiched between the material to be cut 105 and the table 106. Because the value of the drive current for the main axis motor is proportional to a force that is applied to the processing tool 104, it becomes possible to measure a processing load. The acceleration sensor and the acoustic emission sensor are mounted mainly on the chassis 101, the main axial stage 102, or the table 106, and respectively measure the vibration of the machine processing device. An acoustic signal, which is a sound generated along with the vibration of the machine processing device, is collected by a microphone or the like.

The frequency conversion unit 12 is a means for performing frequency conversion on a sensor signal output from the cutting state quantity measurement unit 11. As a method to be used for frequency conversion, a typical technological method such as discrete Fourier transform or Fast Fourier transform can be used. The cutting force component extraction unit 13 is a means for separating cutting force components from the cutting force with the use of the characteristic frequency of the processing tool 104 and the vibration frequency of the cutting force. The cutting-in quantity calculation unit 16 is a means for calculating a radial cutting-in quantity from the harmonic ratios of the cutting force components separated from the cutting force in the cutting force component extraction unit 13. The cutting-in quantity calculation unit 16 calculates a radial cutting-in quantity by obtaining the coefficients of expressions, which are used for calculating the radial cutting-in quantity from the harmonic ratios, or a conversion table from the cutting-in quantity conversion coefficient storage unit 19. Because the expressions that are used for calculating the radial cutting-in quantity are dependent on the number of chips, the intervals between the chips, and the size of the rotation axis, the cutting-in quantity calculation unit 16 obtains these pieces of information from the cutting-in quantity conversion coefficient storage unit 19.

The abnormality detection threshold calculation unit 17 is a means for determining an abnormality detection threshold from the cutting-in quantity calculated in the cutting-in quantity calculation unit 16 using the expressions or the conversion table with reference to information obtained from the processing condition storage unit 18 and the threshold conversion coefficient storage unit 20. The threshold conversion coefficient storage unit 20 stores processing conditions set in a processing condition setting unit 23, cutting-in quantities, and thresholds in association with each other.

The cutting force calculation unit 14 is a means for calculating a cutting force by performing inverse frequency conversion on the cutting force components separated in the cutting force component extraction unit 13. As a method to be used for inverse frequency conversion, a typical technological method such as inverse discrete Fourier transform or inverse Fast Fourier transform can be used. The abnormality determination unit 15 determines an abnormality by comparing a cutting force output from the cutting force calculation unit 14 with a threshold output from the abnormality detection threshold calculation unit 17.

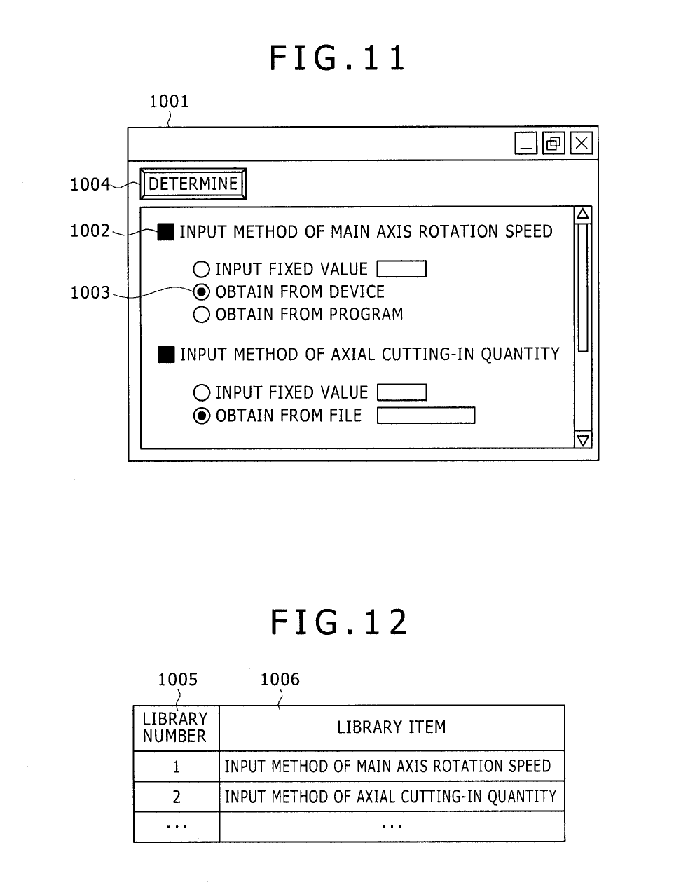

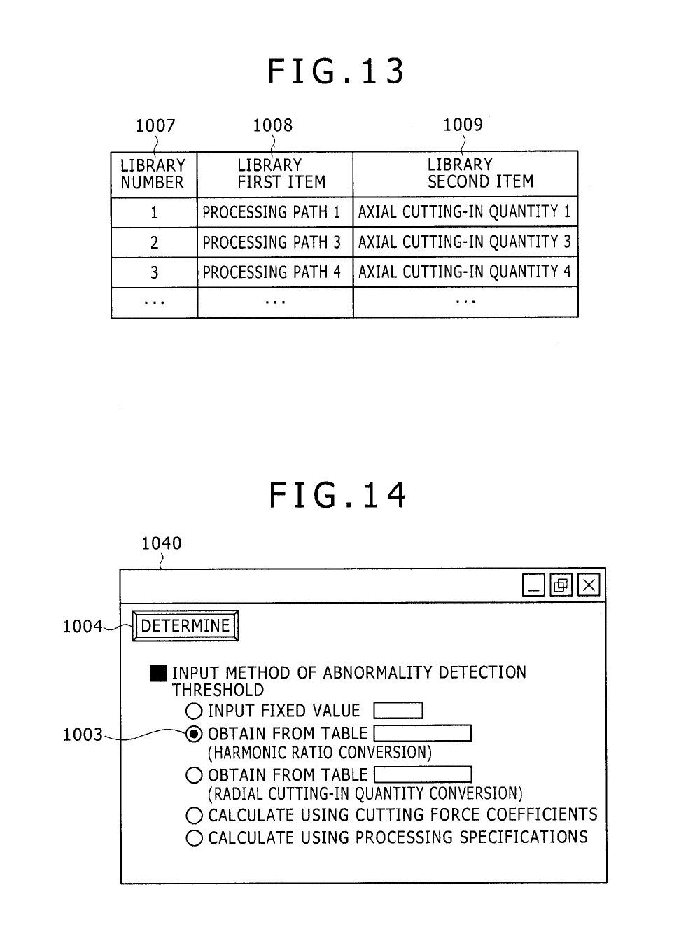

The detail of the processing condition input unit 21 will be described with reference to FIG. 11 to FIG. 13. FIG. 11 is a schematic diagram showing an example of an input screen 1001 where a setting method of processing conditions is input. FIG. 12 is a diagram showing an example of a file format regarding library information shown in FIG. 11. The library information includes, for example, data specified in column “LIBRARY NUMBER” 1005 and column “LIBRARY ITEM” 1006 that includes, for example, “INPUT METHOD OF MAIN AXIS ROTATION SPEED”. Display items 1002 are displayed on the input screen 1001 shown in FIG. 11 on the basis of the library information in FIG. 12, and a condition to be used for each item is selected by pushing a radio button 1003 corresponding to the condition. By pushing “DETERMINE” button 1004 after conditions for all items are selected, the input operation is finished, and the selected conditions for the items are stored in the processing condition storage unit 18. In the case where “OBTAIN FROM DEVICE” is selected in “INPUT METHOD OF MAIN AXIS ROTATION SPEED”, the cutting force component extraction unit 13 extracts cutting force components with the use of the main axis rotation speed that the controller 107 obtains from the machine processing device 100. In the case where “OBTAIN FROM PROGRAM” is selected, a main axis rotation speed is obtained from a program stored in the machine processing device 100 or in the controller 107. Generally speaking, the processing program includes several steps, and it is desirable that a main axis rotation speed should be obtained at each step. FIG. 13 is a diagram showing an example of file information in the case where “OBTAIN FROM FILE” is selected in “INPUT METHOD OF AXIAL CUTTING-IN QUANTITY”. The file information includes, for example, data specified in column “LIBRARY NUMBER” 1007, column “LIBRARY FIRST ITEM” 1008, and column “LIBRARY SECOND ITEM” 1009. Path numbers, or step numbers of the program are input as data in column “LIBRARY FIRST ITEM”, and axial cutting-in quantities are input as data in column “LIBRARY SECOND ITEM”, with the result that an axial cutting-in quantity corresponding to each path or each step number of the program can be set.

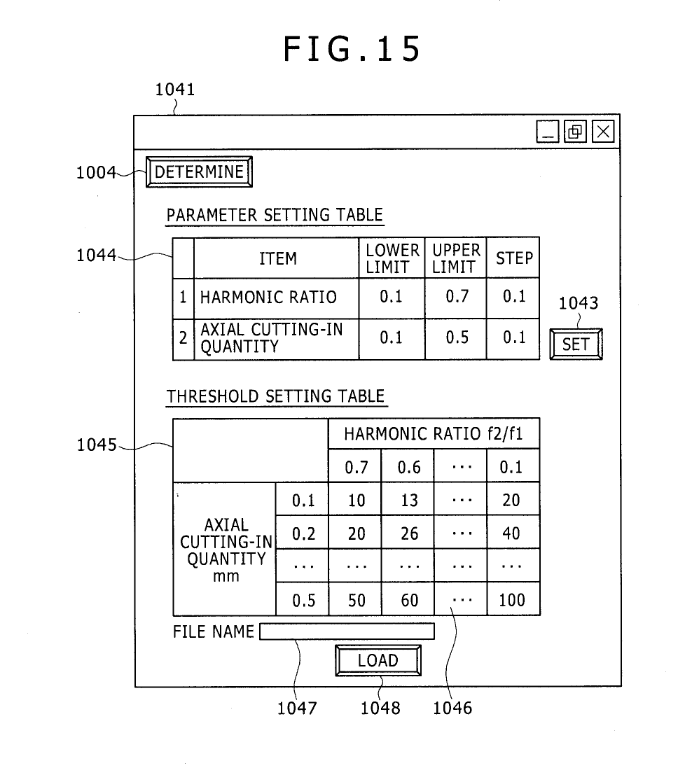

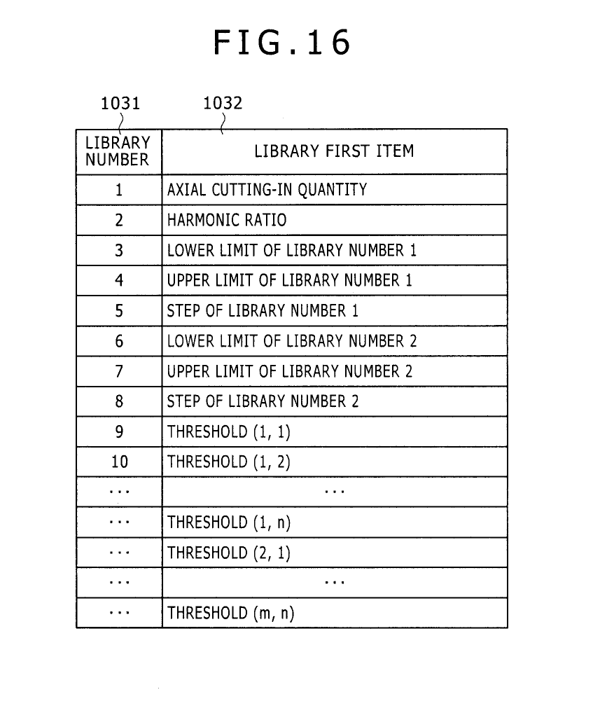

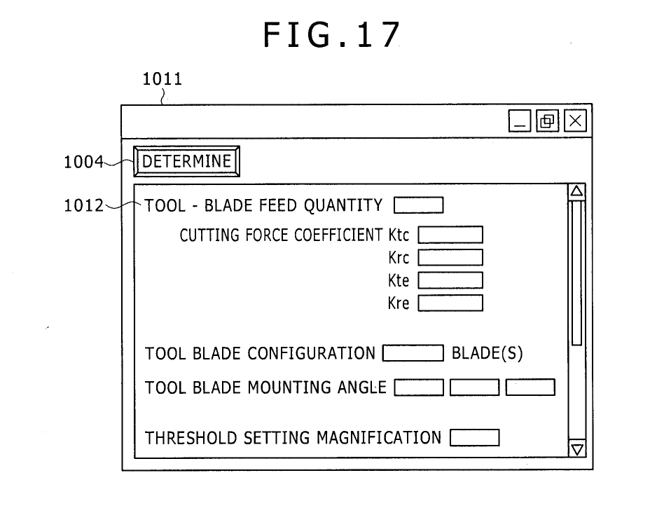

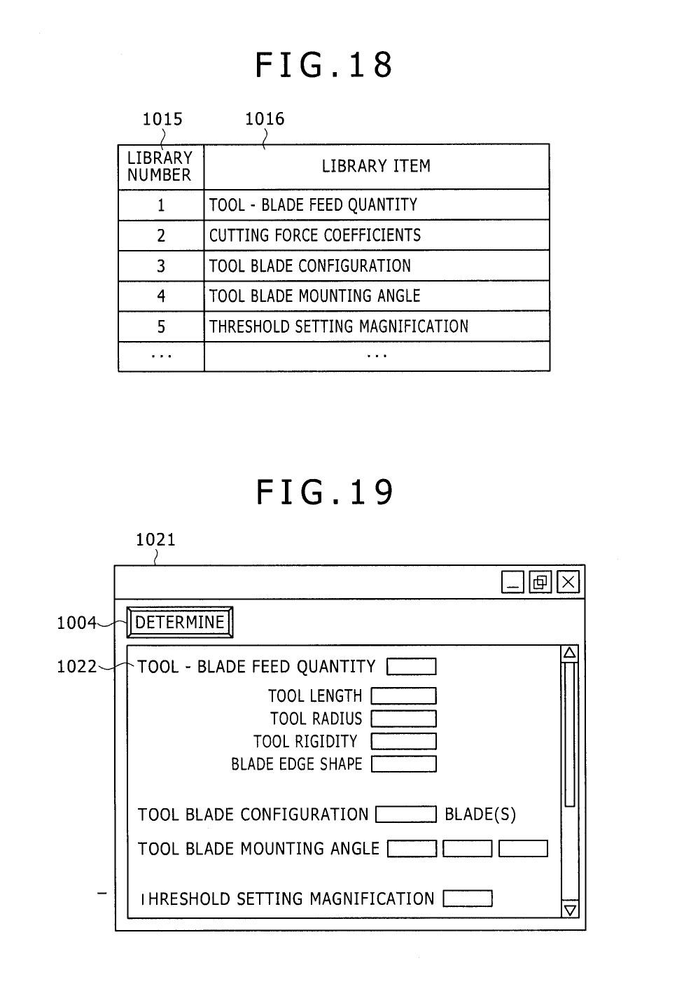

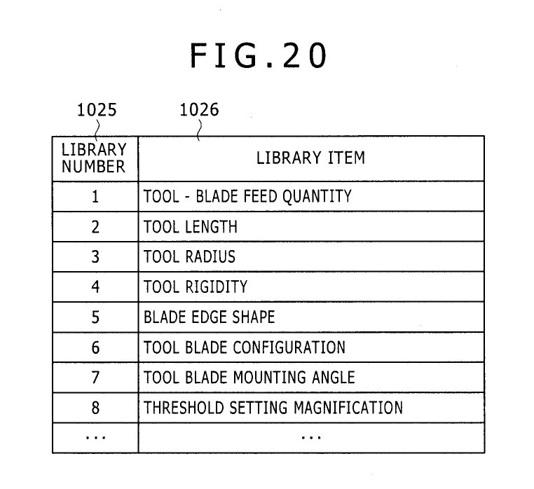

The detail of the threshold condition input unit 25 will be described with reference to FIG. 14 to FIG. 20. FIG. 14 is a schematic diagram showing an example of an input screen 1040 where an input method of an abnormality detection threshold is input. The input screen is configured so that an input method is selected by pushing a radio button 1003 corresponding to the desired input method. FIG. 15 is a diagram showing an example of the outline of an input screen 1041 that is shown when transition from the previous screen occurs after a radio button corresponding to “OBTAIN FROM TABLE” is pushed. The vertical axis of “THRESHOLD SETTING TABLE” 1045 represents axial cutting-in quantities and the horizontal axis represents harmonic ratios or radial cutting-in quantities, and the horizontal axis represents the harmonic ratios or radial cutting-in quantities by switching the harmonic ratios or radial cutting-in quantities in conjunction with the radio button 1003 selected in FIG. 11. FIG. 15 is a diagram showing an example of a screen when “OBTAIN FROM TABLE (HARMONIC RADIO CONVERSION)” is selected in FIG. 14. The number and range of parameters displayed in “THRESHOLD SETTING TABLE” 1045 are determined by numerical values input in “PARAMETER SETTING TABLE” 1044. When “SET” button 1043 is pushed after each item in column “ITEM” is given its lower limit value, its upper limit value, and its step value, the number and values of parameters displayed in “THRESHOLD SETTING TABLE” 1045 are determined in accordance with the input values. When “DETERMINE” button 1004 is pushed after numerical values are input into a threshold input column 1046, the input operation is finished. As an input method of thresholds and parameters, an input method in which these thresholds and parameters are loaded into “THRESHOLD SETTING TABLE” 1045 from a file is conceivable. In this case, by specifying a file loaded into “THRESHOLD SETTING TABLE” 1045 in a “FILE NAME” input field 1047 and pushing “LOAD” button 1048, data can be input into “THRESHOLD SETTING TABLE” 1045. FIG. 16 is a diagram showing an example of file format information of a file loaded into “THRESHOLD SETTING TABLE” 1045. The file information includes the item name of the vertical axis; the item name of the horizontal axis; the lower limit value, the upper limit value, and the step of the vertical axis; the lower limit value, the upper limit value, and the step of the horizontal axis; and thresholds. The number of the thresholds is m×n that is the product of the number m of the steps of the vertical axis and the number n of the steps of the horizontal axis. FIG. 17 is a diagram showing an example of an input screen 1011 that is shown when transition from the previous screen occurs in the case where “OBTAIN USING CUTTING FORCE COEFFICIENTS” is selected in “INPUT METHOD OF ABNORMALITY DETECTION THRESHOLD”. Setting items 1012 based on library information shown in FIG. 18 are displayed on the input screen 1011, and necessary information is input into the setting items 1012. FIG. 19 is a diagram showing an example of an input screen that is shown when transition from the previous screen occurs in the case where “OBTAIN USING PROCESSING SPECIFICATIONS” is selected. Setting items 1022 based on library information shown in FIG. 20 are displayed on an input screen 1021, and necessary information is input into the setting items 1022.

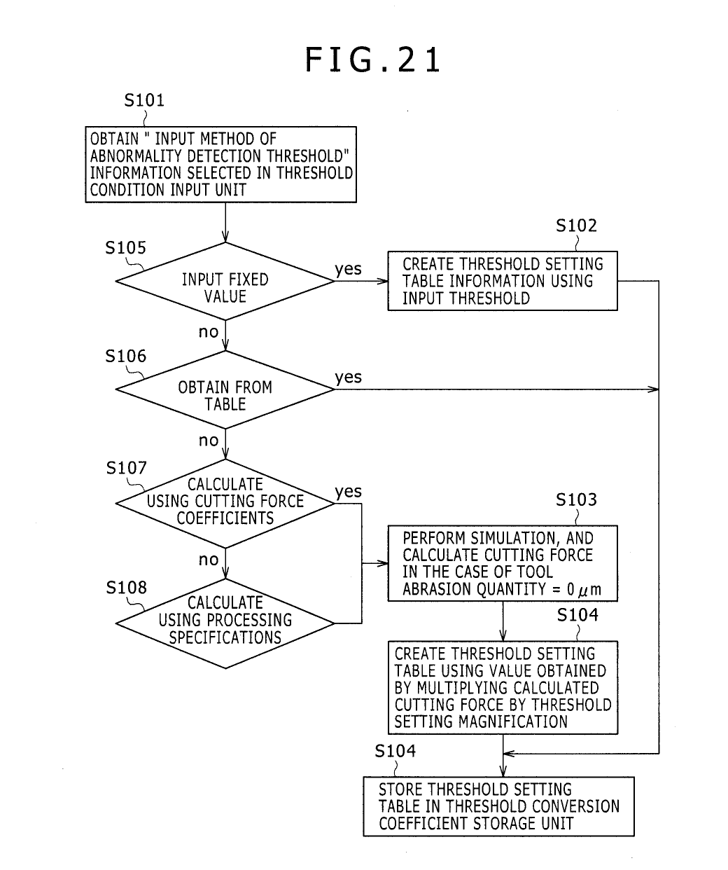

The detail of the threshold conversion coefficient calculation unit 23 will be described with reference to FIG. 21. In the case where a radio button 1003 corresponding to “INPUT FIXED VALUE” is selected in “INPUT METHOD OF ABNORMALITY DETECTION THRESHOLD” shown in FIG. 14, the threshold conversion coefficient calculation unit 23 creates threshold setting table information that includes threshold items of the file format shown in FIG. 16 to which input fixed values are set, and the threshold setting table information is stored in the threshold conversion coefficient storage unit 20. In the case where a radio button 1003 corresponding to “OBTAIN FROM TABLE” is selected, “THRESHOLD SETTING TABLE”, into which data regarding the threshold are input in FIG. 15, is stored in the threshold conversion coefficient storage unit 20. In the case where a radio button 1003 corresponding to “CALCULATE USING CUTTING FORCE COEFFICIENTS” or “CALCULATE USING PROCESSING SPECIFICATIONS” is selected, a simulation is performed on the basis of values input in FIG. 17 or in FIG. 19, and a cutting force in the state of the abrasion quantity of tool being 0 μm is calculated. An abnormality detection threshold is determined by multiplying the calculated cutting force by the value input into “THRESHOLD SETTING MAGNIFICATION” in FIG. 17. By calculating plural thresholds in accordance with the combinations of the axial cutting-in quantities represented by the vertical axis and the harmonic ratios represented by the horizontal axis shown by the example in FIG. 16, data including the file information shown in FIG. 16 are created, and the data are stored in the threshold conversion coefficient storage unit 20. In this case, values stored in advance can be used as the lower limit values, the upper limit values, and the steps of the vertical axis and the horizontal axis. Alternatively, it is conceivable that an input screen is used for inputting the lower limit values, the upper limit values, and the steps of the vertical axis and the horizontal axis.

According to this embodiment, a method, in which a cutting force abnormality detection threshold can be dynamically set in a processing path having a time-varying radial cutting-in quantity, can be provided, which enables defective goods to be prevented from being produced by processing failures, and which enables the production cost to be reduced at the same time.

Although the present invention made by the inventors have been concretely described on the basis of the above embodiment of the present invention, the present invention is not limited to the above embodiment, and it goes without saying that various modifications may be made within the spirit of the present invention.

### LIST OF REFERENCE SIGNS

101 . . . chassis, 102 . . . main axial stage, 103 . . . main axis, 104 . . . processing tool, 105 . . . material to be cut, 106 . . . table, 107 . . . controller, 121 . . . chips, 122 . . . rotation axis

1. A processing abnormality detection method comprising:
measuring a cutting state quantity caused by processing in which a cutting tool is rotated;
extracting cutting force components containing a fundamental and harmonics from the measured signal;
calculating a threshold for abnormality determination on the basis of harmonic ratios that are ratios between the fundamental and harmonics of the cutting force components;
calculating a cutting force from the extracted cutting force components; and
determining an abnormality on the basis of the calculated cutting force and the calculated threshold.

2. The processing abnormality detection method according to claim 1,
wherein, in the step of extracting the cutting force components, frequency conversion is performed on the measured signal and the cutting force components are extracted, and
wherein, in the step of calculating the cutting force, the cutting force is calculated by performing inverse frequency conversion on the cutting force components extracted by the frequency conversion.

3. The processing abnormality detection method according to claim 1, wherein, in the step of calculating the threshold, a radial cutting-in quantity is calculated on the basis of the harmonic ratios, and the threshold is calculated on the basis of the cutting-in quantity.

4. The processing abnormality detection method according to claim 1, further comprising:
calculating an axial cutting-in quantity, wherein, in the step of calculating the threshold, the threshold is set on the basis of the harmonic ratios or a radial cutting-in quantity, and the axial cutting-in quantity.

5. The processing abnormality detection method according to claim 1, wherein, in the step of measuring the cutting state quantity, any of the vibration of a material to be cut, the vibration of a processing device, the current of a motor for rotating the processing tool, and a sound caused by the vibrations is detected as the cutting state quantity.

6. The processing abnormality detection method according to claim 1, wherein the measured signal is coordinately converted into a component tangential and a component perpendicular to an moving average line of a trajectory depicted by the rotation center of the cutting tool, and
wherein the perpendicular component is used in the step of extracting the cutting force components.

7. The processing abnormality detection method according to claim 3, wherein, in the step of calculating the threshold, the radial cutting-in quantity is calculated with the use of a conversion table that records harmonic ratios, each of which is a ratio between the amplitude F1 of a first harmonic of the measured signal to and the amplitude F0 of a fundamental of the measured signal, in association with the respectively corresponding cutting-in quantities, or with the use of expressions.

8. The processing abnormality detection method according to claim 7, wherein the step of calculating the threshold includes:
calculating a plurality of ratios that are a ratio between the amplitude F1 of the first harmonic and the amplitude F0 of the fundamental of the measured signal to a ratio between the amplitude Fn of the nth harmonic and the amplitude F0 of the fundamental of the measured signal;
calculating a plurality of ratios that are a ratio between the amplitude F1 of the first harmonic and the amplitude F0 of the fundamental of a signal obtained from a simulation or an expression to a ratio between the amplitude Fn of the nth harmonic and the amplitude F0 of the fundamental of the signal obtained from the simulation or the expression; and
calculating a cutting-in quantity that makes differences between individual harmonic ratios minimum.

9. A processing device equipped with a cutting tool, a motor for rotating the cutting tool, and a control means for controlling, comprising a measurement means for measuring a cutting state quantity caused by processing in which a cutting tool is rotated,
wherein the control means includes:
an extraction unit for extracting cutting force components containing a fundamental and harmonics from the measured signal;
a threshold calculation unit for calculating a threshold for abnormality determination on the basis of harmonic ratios that are ratios between the fundamental and harmonics of the cutting force components;
a cutting force calculation unit for calculating a cutting force from the extracted cutting force components; and
an abnormality determination unit for determining an abnormality on the basis of the calculated cutting force components and the calculated threshold.

10. The processing device according to claim 9,
wherein the extraction unit extracts cutting force components by performing frequency conversion on the measured signal, and
wherein the cutting force calculation unit calculates the cutting force by performing inverse frequency conversion on the cutting force components extracted by the frequency conversion.

11. The processing device according to claim 9, wherein the threshold calculation unit calculates a radial cutting-in quantity on the basis of the harmonic ratios, and calculates a threshold on the basis of the radial cutting-in quantity.

12. The processing device according to claim 9, further comprising:
an axial cutting-in quantity calculation unit for calculating an axial cutting-in quantity,
wherein the threshold calculation unit sets the threshold on the basis of the harmonic ratios or on the basis of the radial cutting-in quantity and the axial cutting-in quantity.

13. The processing device according to claim 9, wherein the measurement means measures any of the vibration of a material to be cut, the vibration of a processing device, the current of a motor for rotating the processing tool, and a sound caused by the vibrations as the cutting state quantity.

14. The processing device according to claim 9, wherein the threshold calculation unit calculates the threshold with the use of a table that associates ratios between the harmonics and the fundamental with the corresponding cutting-in quantities, or with the use of expressions.

15. The processing device according to claim 9,
wherein the threshold calculation unit calculates the threshold on the basis of a table that associates cutting-in quantities, processing condition information, and abnormality detection thresholds with each other, or on the basis of expressions.

16. The processing device according to claim 9, further comprising:
a means that divides a measured value into a component tangential and a component perpendicular to an moving average line of a trajectory depicted by the rotation center of the rotation axis of the cutting tool.

17. The processing device according to claim 9, further comprising:
a means that obtains a processing condition from a processing condition storage unit, and calculates cutting-in quantity coefficients with the use of a simulation or expressions.

18. The processing device according to claim 15, wherein the processing condition information includes the number of chips and the positions on which the chips are mounted.

19. The processing device according to claim 15, wherein the processing condition information includes the number of chips and the positions on which the chips are mounted.

20. A data input support device for supporting data input in a processing device that measures a cutting state quantity caused by processing in which a cutting tool is rotated, and detects a processing abnormality, comprising:
a processing condition input unit that provides a user with library items of processing conditions used for calculating an abnormality detection threshold, and receives one of the library items of the processing conditions designated by the user;
a threshold condition input unit that provides the user with library items of thresholds used for calculating an abnormality detection threshold, and receives one of the library items of the thresholds designated by the user;
a threshold conversion coefficient calculation unit that calculates a threshold with the use of the one of the library items of the thresholds designated by the user; and
a threshold conversion coefficient storage unit that stores threshold conversion coefficients calculated by the threshold conversion coefficient calculation unit.

21. The data input support device according to claim 20, wherein the threshold conversion coefficient calculation unit calculates the threshold conversion coefficients by a simulation with the use of the threshold condition input by the user.

22. The data input support device according to claim 20, wherein a method for calculating the threshold conversion coefficients is changed in accordance with the input item selected in the threshold condition input unit.

23. The data input support device according to claim 20, wherein the threshold conversion coefficient calculation unit creates data that associates harmonic ratios, axial cutting-in quantities, and abnormality detection thresholds with each other.
